(19) United States
(12) Patent Application Publication
(10) Pub. No.: US 2023/0161216 A1
(43) Pub. Date: May 25, 2023

(54) DISPLAY DEVICE HAVING A WATERMARK FORMED BY HALFTONE IMAGES

(71) Applicant: E Ink California, LLC, Fremont, CA (US)

(72) Inventors: Yih-Ming KANG, Fremont, CA (US); Bryan Hans CHAN, San Francisco, CA (US)

(21) Appl. No.: 18/051,242

(22) Filed: Oct. 31, 2022

Related U.S. Application Data
(60) Provisional application No. 63/281,353, filed on Nov. 19, 2021.

(51) Int. Cl. G02F 1/167; B42D 25/333; G02F 1/1676; G02F 1/1339; G02F 1/1333; G02F 1/133

(52) U.S. Cl. CPC G02F 1/167; B42D 25/333; G02F 1/1676; G02F 1/1339; G02F 1/133374; G02F 1/133377; G02F 1/13324; G02F 1/133394; G02F 2001/1678

(57) ABSTRACT

The present invention is directed to display devices comprising a plurality of microcells. The plurality of microcells comprises different types of microcells having different Fill Factors. The devices have a watermark being formed by halftone images from the different types of microcells. The watermark aims to protect against counterfeiting or to be used for decoration purposes.

### RELATED APPLICATIONS

This application claims priority to U.S. Provisional Patent Application No. 63/281,353, filed on Nov. 19, 2021. The entire contents of any patent, published application, or other published work referenced herein is incorporated by reference.

### FIELD OF THE INVENTION

The present invention is directed to an electrophoretic display device that has a watermark. The electrophoretic display device comprises a plurality of microcells separated from each other by partition walls, each microcell including an electrophoretic medium. The watermark is formed by halftone images from the partition walls of the plurality of microcells. The display device comprising the watermark feature is useful for protecting against counterfeiting or for decoration purposes.

### BACKGROUND OF INVENTION

The term “electro-optic”, as applied to a material or a display or a display device, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic display devices in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display devices, and should be understood as normally including extreme optical states which are not strictly black and white, for example the aforementioned white and dark blue states. The term “monochrome” may be used hereinafter to denote a drive scheme that only drives pixels to their two extreme optical states with no intervening gray states.

Some electro-optic materials are solid in the sense that the materials have solid external surfaces, although the materials may, and often do, have internal liquid- or gas-filled spaces. Such display devices that use solid electro-optic materials may hereinafter be referred to as “solid electro-optic displays” for convenience. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to display devices comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic display devices capable of gray scale are stable not only in their extreme black and white states but also in their intermediate gray states, and the same is true of some other types of electro-optic displays. This type of display device is properly called “multi-stable” rather than bistable, although for convenience the term “bistable” may be used herein to cover both bistable and multi-stable display devices.

One type of electro-optic display device, which has been the subject of intense research and development for a number of years, is the particle-based electrophoretic display device, in which a plurality of charged particles move through a fluid under the influence of an electric field. Electrophoretic display devices can have attributes of good brightness and contrast, wide viewing angles, state bistability, and low power consumption when compared with liquid crystal displays. Nevertheless, problems with the long-term image quality of these display devices have prevented their widespread usage. For example, particles that make up electrophoretic display devices tend to settle, resulting in inadequate service-life for these display devices.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically mobile particles in a fluid medium, and a capsule wall surrounding the internal phase. Typically, the capsules are themselves held within a polymeric binder to form a coherent layer positioned between two electrode layers. In a microcell electrophoretic display, the charged particles and the fluid are not encapsulated within microcapsules but instead are retained within a plurality of cavities formed within a carrier medium, typically a polymeric film. Hereinafter, the term “microcavity electrophoretic display” may be used to cover both encapsulated and microcell electrophoretic displays. The technologies described in these patents and applications include:

(a) Electrophoretic particles, fluids and fluid additives; see for example U.S. Pat. Nos. 7,002,728 and 7,679,814.

(b) Capsules, binders and encapsulation processes; see for example U.S. Pat. Nos. 6,922,276 and 7,411,719.

(c) Microcell structures, wall materials, and methods of forming microcells; see for example U.S. Pat. Nos. 7,072,095 and 9,279,906.

(d) Methods for filling and sealing microcells; see for example U.S. Pat. Nos. 7,144,942 and 7,715,088.

(e) Films and sub-assemblies containing electro-optic materials; see for example U.S. Pat. Nos. 6,982,178 and 7,839,564.

(f) Backplanes, adhesive layers and other auxiliary layers and methods used in displays; see for example U.S. Pat. Nos. 7,116,318 and 7,535,624.

(g) Color formation and color adjustment; see for example U.S. Pat, Nos. 7,075,502 and 7,839,564.

(h) Methods for driving displays; see for example U.S. Pat. Nos. 7,012,600 and 7,453,445.

(i) Applications of displays; see for example U.S. Pat. Nos. 7,312,784 and 8,009,348.

(j) Non-electrophoretic displays, as described in U.S. Patent Applications Publication No. 2015/0277160; and applications of encapsulation and microcell technology other than displays; see for example U.S. Patent Application Publications Nos. 2015/0005720 and 2016/0012710.

U.S. Pat. Nos. 6,930,818 and 6,795,138 disclose image display devices based on the microcell technology. The patents describe the manufacture of microcells as display microcells. The microcells are then filled with an electrophoretic fluid. The top openings of the microcells may have the same size and shape and such microcells spread across the entire display surface.

U.S. Pat. Nos. 9,470,917, 10,401,668, 10,831,052, 9,436,057, 10,073,318, and 10,100,528 disclose image display devices based on the microcell technology. The microcells of the image display devices are separated by microcell walls. The image display devices have a watermark area and a non-watermark area. The thickness of the partition walls, the height of the partition walls, the top opening of the microcells, the microcell size, or the bottom thickness of the microcells in the watermark area are different from those of the microcells in the non-watermark area.

The displays of the prior art enable the presence of watermark by the presence of two different types of microcells in the watermark area. However, they are not able to form a realistic high quality watermark image that resembles the result of halftoning in the printing field. The present invention achieves such a result, improving the aesthetic value and counterfeiting capabilities of the watermark.

### SUMMARY OF INVENTION

One aspect of the present invention is directed to an electro-optic display device comprising an electro-optic material layer. The electro-optic material layer comprises a plurality of microcells, which are separated from each other by partition walls. The partition walls of each microcell have a surface area. Each microcell of the plurality of microcells has a microcell opening, the microcell opening having a surface area and a Fill Factor. Each microcell of the plurality of microcells includes electrophoretic medium, the electrophoretic medium comprising charged pigment particles in a non-polar fluid. The electro-optic display device has a viewing side, a side opposite to the viewing side, and a watermark being formed by halftone images from the plurality of microcells. The plurality of microcells comprise more than five types of microcells. Each microcell of a type of microcells has a Fill Factor that is different from the Fill Factors of all microcells of other types of microcells. The Fill Factor of a microcell is determined by Equation 1,

Fill Factor=A₁/(A₁+A₂) Equation 1,

A₁ being the surface area of the microcell opening, and A₂ being the surface area of the partition walls that surround the microcell.

The plurality of microcells of the electro-optic material layer of the electro-optic display device may comprise more than six types of microcells, or more than seven types of microcells, or more than eight times of microcells, or more than nine types of microcells, or more than ten types of microcells, or more than twelve types of microcells, or more than fifteen types of microcells. Each microcell of a type of microcells has a Fill Factor that is different from the Fill Factors of all microcells of other types of microcells. The electro-optic display device may comprise microcells having the same Fill Factor, but different partition wall height. The electro-optic display device may comprise microcells having the same Fill Factor, but different microcell shape.

The partition walls of the electro-optic material layer of the electro-optic display device may be opaque or transparent. The electro-optic display device may comprise at least two types of partition walls, a first type and a second type of partition walls, the first type and the second type of partition walls having different colors.

The electro-optic display device may further comprise a first light-transmissive electrode layer and a second electrode layer, wherein the electro-optic material layer is disposed between the first electrode layer and the second electrode layer. The second electrode layer may be also light-transmissive. The first light-transmissive electrode layer may be colored or colorless. The second light-transmissive electrode layer may be colored or colorless.

The electro-optic display device may further comprise a sealing layer spanning the opening of each microcell of the plurality of microcells. The sealing layer may be disposed between the electro-optic material layer and the second electrode layer. The sealing layer may be opaque or transparent. The sealing layer may be colored or colorless.

The electro-optic display device may comprise an adhesive layer disposed between the sealing layer and the second electrode layer. The adhesive layer may be transparent. The adhesive layer may be colored or colorless. If the partition walls are transparent, the sealing layer may be transparent, and the adhesive layer may be opaque, the adhesive layer being also colored. If the partition walls are transparent, the sealing layer may be also transparent, the adhesive layer may also be transparent, and the second electrode layer may be colored. If a layer is colored, the color of the colored layer may be selected from the group consisting of white, black, gray, red, green, blue, magenta, cyan, yellow, orange, and violet.

The electro-optic display device may comprise a piezoelectric layer comprising a piezoelectric material. The piezoelectric layer may be located adjacent to the electro-optic material layer. The electro-optic display device may comprise a photovoltaic layer to harvest light and power the device without the need for external power supply.

The electro-optic display device may be used as part of a product, a document, or a currency bill for anti-counterfeiting purpose.

### BRIEF DESCRIPTION OF DRAWINGS

FIG. 1 shows a cross-sectional view of an electro-optic display device that comprises a plurality of microcells.

FIG. 2 illustrates a top view of an electro-optic display device that comprises a plurality of microcells.

FIGS. 3 and 4 illustrate a top view of a plurality of microcells having different types of microcells.

FIGS. 5 and 6 illustrate a top view of a plurality of microcells having numerous types of microcells.

FIGS. 7 and 8 shows examples of devices having watermarks formed by halftone images.

FIGS. 9, 10, and 11 illustrate a cross-sectional view of devices that contain a colored layer.

FIG. 12 shows a method for making microcells for the invention using a roll-to-roll process.

FIGS. 13A and 13B detail the production of microcells for an electro-optic display device using photolithographic exposure through a photomask of a conductor film coated with a thermoset precursor.

FIGS. 13C and 13D detail an alternate embodiment in which microcells for an electro-optic display device are fabricated using photolithography. In FIGS. 13C and 13D a combination of top and bottom exposure is used, allowing the partition walls in one lateral direction to be cured by top photomask exposure, and the partition walls in another lateral direction to be cured by bottom exposure through the opaque base conductor film.

FIGS. 14A-14D illustrate the steps of filling and sealing an array of microcells to be used in an electro-optic display device.

FIGS. 15A and 15B illustrate electro-optic display devices that comprises a piezoelectric layer.

### DETAILED DESCRIPTION

The present inventors have found that a watermark may be added to a display device, which watermark is useful to protect against counterfeiting when a security measure is required for the display device. In addition, the watermark may also be used for ornamental design/decoration purposes.

Watermark is a fixed image that may be present on a paper, a document, an electronic display or other image substrates that is typically used for authentication, identification, or aesthetic reasons. Watermark is sometimes designed to be visible at specific viewing angles or by transmitted light or by reflected light under certain conditions such as a dark background etc.

Halftone image is a technique used in the publication industry to produce an image by using dots of varying size and spacing. It enables the production of very high quality images. The term “dot” is not specific to any particular shape. When halftone dots are very small, the human eye sees a continuous, smooth tone, although under a microscope individual dots are distinguishable.

The term “light-transmissive” and “transparent” referring to a layer A are synonymous and used herein to mean that the layer thus designated transmits sufficient light to enable an observer, looking, through that layer, to observe the image or color that is present in layer B, wherein layer A is between the observer and layer B. Specifically, a light-transmissive or transparent layer transmits 60 percent or more of the incident visible light. If the layer transmits less than 60 of the incident visible light, the layer is opaque.

“Adhesive layer” of the electro-optic display device is a layer that establishes an adhesive connection between two other layers of the device. An adhesive layer may have thickness of from 200 nm to 5 mm, or from 1 μm to 100 μm.

The term “microcell shape” refers to the two dimensional shape of the microcell opening as viewed from an observer looking from above the opening.

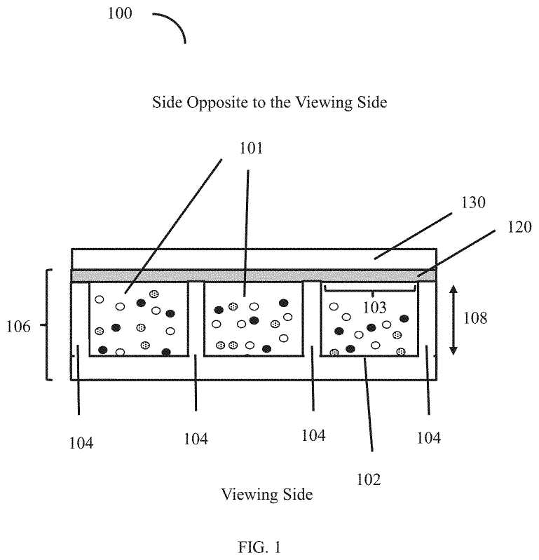

The term “partition wall height” refers to the distance between the floor of the microcell cavity at the partition wall and the top partition wall. It defines the microcell depth and it is shown in FIG. 1 (108).

The electro-optic display device of the present invention has a viewing side and a side opposite to the viewing side as shown in FIG. 1. The electro-optic display comprises an electro-optic material layer 106 comprising a plurality of microcells. Three microcells 101 are shown in the electro-optic display device 100 of FIG. 1. The microcells have a floor 102 and an opening 103, the opening 103 having a perimeter. Each microcell may correspond to multiple partition walls 104 that separate the microcell from adjacent microcells. The height of the partition walls 108 of a microcell, defining the depth of the microcell, refers to the distance between the floor of the microcell at a partition wall and the top of the partition wall. The height of the partition walls of a microcell may be from 0.5 mm to 3 μm, or from 300 μm to 5 μm, or from 250 μm to 10 μm, or from 200 μm to 12 μm, or from 100 μm to 15 μm, or from 50 μm to 20 μm. The electro-optic material layer 106 of the electro-optic display device 100 may comprise a sealing layer 120. The sealing layer 120 spans the opening 103 of each microcell. The electro-optic display device may comprise a substrate 130.

The microcells of the electro-optic display device contain electrophoretic medium comprising charged pigment particles. In the example of the electro-optic device illustrated in FIG. 1, there are three types of charged pigment particles illustrated by black, white, and gray circles. The gray circles may represent a color that is different form white or black.

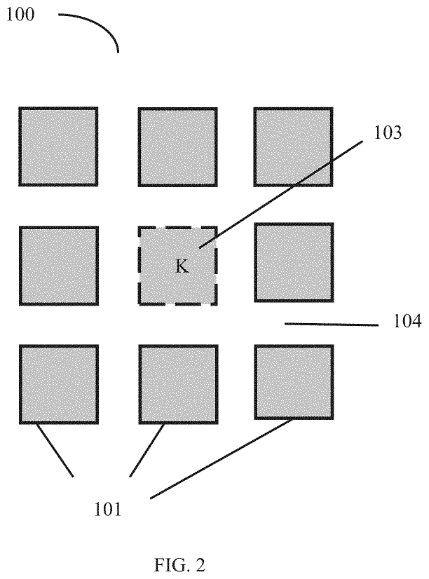

FIG. 2 illustrates part of the electro-optic display device viewed from a side of the display device that is nearer to the microcell openings. Nine microcells (101) are shown in FIG. 2. Microcell K (in the center of FIG. 2) is separated from its neighboring microcells by partition walls 104. The dotted line illustrates the perimeter of the opening of microcell K. The surface area of the microcell opening for microcell K is simply the surface area inside the perimeter of the opening.

The electro-optic display device may comprise a sealing layer, the sealing layer spanning the microcell openings of the electro-optic material layer. The sealing layer seals the electrophoretic medium inside the microcells. The electro-optic material layer may be disposed between a first electrode layer and a second electrode layer. In electro-optic display devices that comprise a sealing layer spanning the openings of each of the plurality of microcells, the electro-optic display device may comprise an adhesive layer disposed between the sealing layer and the second electrode layer or between the sealing layer and the first electrode layer. The sealing layer may be transparent. The adhesive layer may also be transparent.

The second electrode layer may comprise a plurality of electrodes (pixel electrodes) that can be addressed independently to each other. Thus, a variable image is enabled throughout the display device.

The electro-optic display device may comprise an electro-optic material layer having six types of microcells. Each type comprises microcells having the same Fill Factor. Each type of microcells has Fill Factor that is different from the Fill Factor of the microcells of all the other types of microcells. The electro-optic display device comprises an electro-optic material layer having more than six types of microcells, or more than seven types of microcells, or more than eight types of microcells, or more than nine types of microcells, or more than ten types of microcells, or more than twelve types of microcells, or more than fifteen types of microcells, or more than twenty types of microcells, or more than thirty types of microcells.

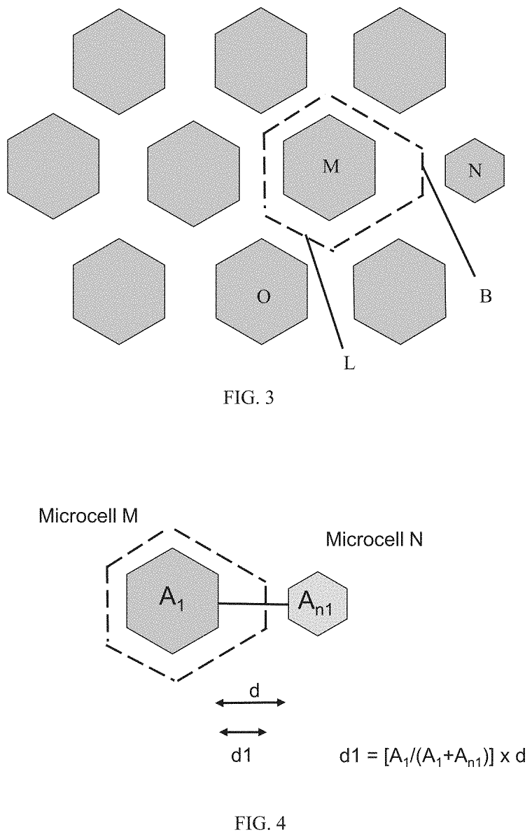

The surface area of a partition wall of a microcell refers to the area of the surface of the partition wall, which is on the same plane of the microcell opening, or on a plane that is parallel to the plane of the microcell opening. That is, assuming that an observer can observe the microcell openings and the upper surface of the partition walls of a microcell vertically from the side of the device that is closer to the microcell opening (versus the side opposite to the microcell floor), the surface area of the partition walls that surround the microcell can be determined as shown in FIGS. 3 and 4 and the corresponding descriptions.

Each microcell of the electro-optic display device has a Fill Factor. The Fill factor of a microcell provides a measure of the surface of the electro-optic material layer that is electro-optically active. Electrically active means that the image displayed on the surface can be variable. The Fill Factor of a microcell is determined by Equation 1.

Fill Factor=A₁/ (A₁+A₂) (Equation 1),

A₁ is the surface area of the microcell opening, and A₂ is the surface area of the partition walls that surround the microcell as viewed from the side of the electro-optic display device that is closer to the microcell opening (versus from the side that is closer to the microcell floor). Surface area A₂ of the partition wall of microcell M (or any microcell) is determined by the method described below.

One scenario, illustrated in FIGS. 3 and 4, involves an electro-optic display device having hexagonal microcell openings. FIGS. 3 and 4 illustrate a view of part of the device from the side of the device that is closer to the microcell openings. In this scenario, microcell M has surface area of microcell opening A₁, and microcell M is adjacent to other microcells, including microcell N. Microcell N has surface area of microcell opening Aₙ₁ that is different from that of A₁. In this case, surface area A₁ of the microcell opening of microcell M is larger than surface area Aₙ₁ of the microcell opening of microcell N. As a first step for the determination of A₂, the partition wall that separates microcells M and N is divided by a borderline B. Borderline B is a line on the surface of the partition wall that separates microcell M and microcell N. Borderline B is defined by a series of points being at a distance d1 from each point of the opening perimeter of microcell M and between the two microcells, where d1 is provided by Equation 2,

d1=[A₁/(A₁+Aₙ₁)]×d (Equation 2),

d being the distance between the point of the opening perimeter of microcell M from the closest point at the opening perimeter of microcell N. That is, microcell N is the microcell whose opening perimeter is closest to the specific point of the opening perimeter of microcell M.

The process of defining the borderline to the partition wall that separates microcell M and all the other microcells that are adjacent to microcell M (other than N) is repeated, until the borderline that surrounds microcell N is defined and completed as a closed line. A microcell is considered to be adjacent to microcell N, if any point in the opening perimeter of microcell N is closer in distance to any point in the opening perimeter of microcell M than any point in the opening perimeter of any other microcell of the device.

In another scenario of the same display device, also shown in FIG. 3, microcell M has surface area of microcell opening Ai, and microcell M is adjacent to microcell O. Microcell O has surface area of microcell opening Aₒ₁ that is the same as Aᵢ. In this scenario, the borderline on the surface of the partition wall that separates microcells M and O is divided by a borderline L. in the midpoint between the opening perimeter of microcell M and the opening perimeter of microcell O. The process of defining the borderline to the partition wall that separates microcell M and all the other microcells that are adjacent to microcell M (other than O) is repeated, until the borderline that surrounds microcell N is defined and completed as a closed line (see dotted line in FIGS. 3 and 4).

Having defined the borderline that surrounds a microcell, the surface area of the partition wall A₂ can be geometrically calculated or graphically measured for the corresponding microcell. After the determination of surface area A₂ and given surface area A₁, which is the readily geometrically calculated or graphically determined surface area of the microcell opening, the Fill Factor for the specific microcell can be calculated from Equation 1. It is assumed that every unit area of a partition wall that separates two microcells M and N from each other is either part of the surface area of the partition walls that surround microcell M (A₂) or part of the surface area of the partition walls that surround microcell M (Aₙ₂), and not part of any other microcell of the plurality of microcells.

A piezoelectric material is a material that can generate an electric charge in response to applied mechanical stress. When mechanical stress is applied on a piezoelectric material, positive and negative charge centers in the material shift, which results in the generation of an electric field that can be used to operate devices without the need of a battery or an external power supply. For example, by bending or introducing mechanical stress to a device that comprises piezoelectric material, a voltage may be generated. This voltage can be utilized to operate the device. Non-limiting examples of piezoelectric materials include polyvinylidene fluoride (PVDF), quartz (SiO₂), berlinite (AlPO₄), gallium orthophosphate (GaPO₄), tourmaline, barium titanate (BaTiO₃), lead zirconate titanate (PZT), zinc oxide (ZnO), aluminum nitride (AlN), lithium tantalite, lanthanum gallium silicate, and potassium sodium tartrate. Examples of piezoelectric electrophoretic displays are disclosed in U.S. patent application Ser. No. 16/415,022, published as US 2019/0352973, which is incorporated by reference herein in its entirety. In the present invention, a layer comprising piezoelectric material may be used to operate the electro-optic display device, such as driving the charged pigment particles of the electrophoretic material layer to change the color state of the electrophoretic display device.

The electro-optic display device of the present invention may also be a light-harvesting device. That is, it can gather energy for its operation by converting incident light energy into electrical energy. This can be achieved by including a photovoltaic cell layer at a surface of the electro-optic display device or at or near a surface of a substrate to which the electro-optic display device is attached. Examples of light-harvesting electrophoretic display devices are disclosed in U.S. patent application Ser. No. 16/815,269, published as US 2020/0295222, which is incorporated by reference herein in its entirety. The electric energy that is generated by incident light energy can drive the charged pigment particles of the electrophoretic material layer to change the color state of the electrophoretic display device.

The watermark feature is achieved by designing an electro-optic material layer that has a plurality of microcells of various types. The various types of microcells have different Fill Factors. The combination of microcells having different Fill Factors parallels the “dots” of halftone images, which is a technique that is used in the printing industry to generate high quality images.

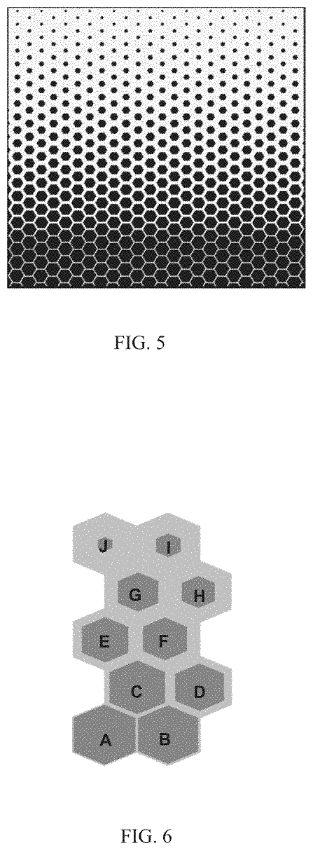

FIGS. 5, 6, 7 and 8 illustrate top views of electro-optic display devices according to the present invention. FIG. 5 illustrates a device comprising a plurality of microcells that have hexagonal openings. The device comprises microcell walls that appear white. All the microcells of the device exist in the dark state. The plurality of microcells comprises various types of microcells having different Fill Factors. The lower part of the electro-optic device of FIG. 5 has microcells with large Fill Factors; the surface area of the microcell openings is much larger than the surface area of the partition wall surrounding the microcells. Moving from the microcells at the bottom of FIG. 5 towards the top, the Fill Factors of the microcells become progressively smaller. Thus, this electro-optic display device comprises numerous types of microcells (having different Fill Factors). In fact, every row of microcells of this device comprises a different microcell type from all the other rows, forming halftone images. This results in the watermark shown in FIG. 5. The Fill Factor of a microcell of an electro-optic display device of the present invention may be from 0.01 to 0.99, or from 0.10 to 0.90, or from 0.15 to 0.85.

FIG. 6 illustrates a partial top view of an electro-optic display device, showing ten microcells (A-J). In this instance, each microcell of the ten microcells has different Fill Factor from the other nine microcells. Thus, for this part of the device, each microcell represent a different type of microcells.

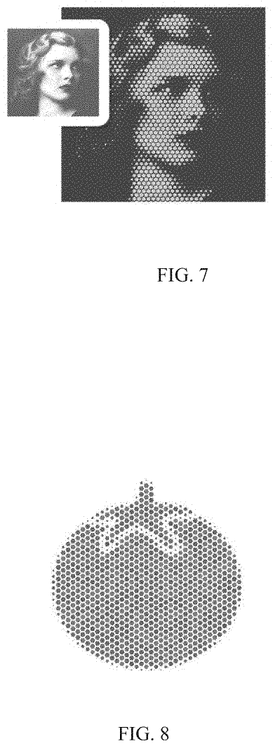

FIGS. 7 and 8 illustrate other examples of watermarks created by halftone images from microcells comprising numerous types of microcells having different Fill Factors. The watermarks that are created in this manner represent detailed and accurate images, improving the aesthetic value and the authentication and anti-counterfeiting capabilities of the devices.

The improved the aesthetics and authentication capabilities of the electro-optic display device of the present invention also depends on the fact that the devices are able to display variable images. The electro-optic display device comprises an electro-optic material layer having a plurality of microcells. Each microcell of the plurality of microcells comprises charged pigment particles in a non-polar fluid that can move towards the viewing side or towards the side opposite to the viewing side of the device, depending on the applied electric filed across the electro-optic material layer. The electric field may be applied via a first electrode layer and a second electrode layer, wherein the electro-optic material layer is located between the first and the second electrode layers. Thus, each microcell can have variable color and the device can display the desired image, in addition to the fixed watermark image formed by the different types of microcells having different Fill Factors.

Specifically, in one example, the plurality of microcells include an electrophoretic medium comprising one type of charged pigment particles in a non-polar fluid. The non-polar fluid maybe dyed by a soluble dye or it may be not colored. When a voltage potential is applied between the first and second electrode layers on a microcell, the charged pigment particles migrate via the electrophoretic medium towards one side of the microcell causing either the color of the pigment particles or the color of the solvent being seen from the viewing side.

In another example, the plurality of microcells include an electrophoretic medium comprises two types of charged pigment particles in a non-polar fluid, such as white pigment particles and black pigment particles. The first type of pigment particles have a first charge polarity and the second type of pigment particles have a second charge polarity. The second charge polarity is opposite to the first charge polarity. In this case, when a voltage difference is imposed between the first and second electrode layers across a microcell, the two types of the charged pigment particles move via the electrophoretic medium to opposite ends of the microcell. Thus, one of the colors of the two types of the charged pigment particles would be seen at the viewing side of the microcell.

In another example, the plurality of microcells include an electrophoretic medium comprising three types of charged pigment particles in a non-polar fluid, a first type of charged pigment particles, a second type of charged pigment particles, and a third type of charged pigment particles. The first and second types of charged pigment particles have first charged polarity and the third type of charged pigment particles have second charge polarity, the second charge polarity being opposite to the first charge polarity.

In another example, the plurality of microcells include an electrophoretic medium comprising four types of charged pigment particles in a non-polar fluid, a first type of charged pigment particles, a second type of charged pigment particles, a third type of charged pigment particles, and a fourth type of charged pigment particles. The first and second types of charged pigment particles have first charged polarity and the third and fourth type of charged pigment particles have second charge polarity, the second charge polarity being opposite to the first charge polarity. The first type of charged pigment particles may have higher charge than the second charged pigment particles and the third type of charged pigment particles may have higher charge than the fourth type of charged pigment particles.

In another example, the plurality of microcells include an electrophoretic medium comprising four types of charged pigment particles in a non-polar fluid, a first type of charged pigment particles, a second type of charged pigment particles, a third type of charged pigment particles, and a fourth type of charged pigment particles. The first, second and third types of charged pigment particles have first charged polarity and the fourth type of charged pigment particles has second charge polarity, the second charge polarity being opposite to the first charge polarity. The first type of charged pigment particles may have higher charge than the second charged pigment particles and the third type of charged pigment particles may have higher charge than the second type of charged pigment particles.

In other examples, the plurality of microcells include an electrophoretic medium comprising five or six types of charged pigment particles in a non-polar fluid.

The charged pigment particles in the electrophoretic medium may comprise charged pigment particles having colors selected from the group consisting of white, black, cyan, magenta, yellow, red, blue, and green.

The microcell openings may have different shapes, for example, triangular, square, round, oval or polygonal, such as hexagonal (honeycomb) structure. The same electro-optic material layer may have various microcell shapes.

Each microcell opening of the plurality of microcells may have microcell width that is smaller than 300 μm. Width of a microcell opening is defined as the longest straight distance between two points of the perimeter of the microcell opening. The microcell width may be different in each type of microcells. Even microcells of the same type may have different widths. The width of a microcell opening may be in a range between 300 μm to 1 μm, or from 250 μm to 5 μm, or from 200 μm to 10 μm, or from 2 mm to 2 μm, or from 1 mm to 4 μm, or from 800 μm to 8 μm, or from 500 μm to 10 μm, or from 400 μm to 12 μm, or from 300 μm to 15 μm. The partition wall width (or, synonymously, the microcell wall thickness; represented by d in FIG. 4) that separates microcell openings may also range between 2 mm to 3 μm, or 1 mm to 5 μm, or from 800 μm to 8 μm, or from 500 μm to 10 μm, or from 400 μm to 12 μm, or from 300 μm to 15 μm, or from 300 μm to 1 μm.

The electro-optic display device of the present invention may comprise microcells of a microcell type, that is, microcells having the same Fill Factor, but different partition wall heights or different shapes. Different wall heights may be achieved by varying the bottom thickness of the microcell. That is, the floor of the microcells may be positioned in different heights inside the microcells.

The electro-optic display device of the present invention may comprise microcells of a microcell type, that is, microcells having the same Fill Factor, but different partition wall color. In addition, the electro-optic display device of the present invention may comprise different types of microcells (having different Fill Factors), wherein there are two types of microcells that have partition walls with different colors.

The watermark created according to the present invention may be visible at certain viewing angles and/or under certain lighting conditions. The watermark would not interfere with the desired regular images displayed (based on movement of charged pigment particles in a fluid of the electrophoretic medium).

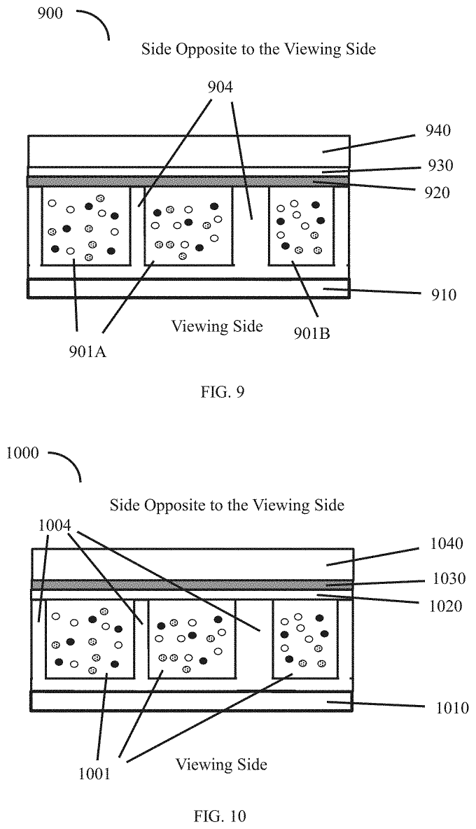

An example of an electrophoretic display device of the present invention is provide in FIG. 9. FIG. 9 is a cross-sectional view of a portion of device 900 comprising a first electrode layer 910, microcells 901A and 901B with partition walls 904, sealing layer 920, an optional adhesive layer 930, and a second electrode layer 940. The device has a viewing side and a side opposite to the viewing side. In this example, the sealing layer may be located closer to the side away from the viewing side of the device in relation to the microcell cavity comprising the electrophoretic medium. However, in other device examples, the sealing layer may be located closer to the viewing side in relation to the microcell cavity comprising the electrophoretic medium.

In a first embodiment of the present invention, the partition walls are opaque. The opaque partition walls of the device may all have a single color or various partition walls throughout the device may have different colors.

In a second embodiment of the present invention, the partition walls may be transparent. In this second embodiment, the device may comprise a layer that is colored, which may enhance the appearance of the watermark. The sealing layer may also be opaque or transparent. In the example illustrated in FIG. 9, the sealing layer may be opaque and located closer to the side away from the viewing side of the device in relation to the microcell cavity comprising the electrophoretic medium. In this example, the sealing layer may be colored.

Given that the first electrode layer and the partition walls are transparent, the color of the opaque sealing layer will be visible for an observer looking from the viewing side of the device. That is, the watermark will appear to have the color of the sealing layer. The watermark will be visible to the observer, if the optical states of the electrophoretic medium of the relevant microcells are distinguishable from that of the sealing layer.

In another example of the second embodiment of the electro-optic display device, the sealing layer is transparent. In this example, the device comprises an adhesive layer that is located between the sealing layer and the second electrode layer. The adhesive layer may be opaque. This example, where the sealing layer is transparent and the adhesive layer is opaque, is illustrated in FIG. 10. FIG. 10 illustrates a side view of electro-optic display device 1000 comprising first electrode 1010, microcells 1001 having partition walls 1004, sealing layer 1020, adhesive layer 1030, and second electrode layer 1040. In this example of electro-optic display device 1000, the adhesive layer 1030 may be colored. Given that first electrode layer 1010, partition walls 1004, and sealing layer 1020 are all transparent, the color of the opaque adhesive layer 1030 will be visible for an observer looking from the viewing side of the device. That is, the watermark will appear to have the color of adhesive layer 1030. The watermark will be visible to the observer, if the states of the electrophoretic medium of the relevant microcells are distinguishable from that of adhesive layer 1030. The color appearance of the watermark may be controllably modified further by including a dye in transparent sealing layer 1020.

In yet another example of the second embodiment of the electro-optic display device, both the sealing and adhesive layers are transparent. The second electrode layer may be opaque. This example, where the sealing and adhesive layers are transparent and the second electrode layer is opaque, is illustrated in FIG. 11. FIG. 11 illustrates a side view of electro-optic display device 1100 comprising a first electrode 1110, microcells 1011 having partition walls 1104, sealing layer 1120, adhesive layer 1130, and second electrode layer 1140. In this case, second electrode layer 1140 may be colored. Given that first electrode layer 1110, partition walls 1104, sealing layer 1120, and adhesive layer 1130 are all transparent, the color of the opaque second electrode layer 1140 will be visible for an observer looking from the viewing side of the device. That is, the watermark will appear to have the color of adhesive layer 1130. The watermark will be visible to the observer, if the states of the electrophoretic medium of the relevant microcells are distinguishable from that of the second electrode layer. The color appearance of the watermark may be controllably modified further by including a dye in the transparent sealing layer 1120 and/or in the transparent adhesive layer 1130.

In the case where the sealing layer is located closer to the viewing side of the device in relation to the microcell cavity comprising the electrophoretic medium, the sealing layer is transparent. In this case, analogous analysis would show that layers that are located on the other side of the electro-optic material layer in relation to the sealing layer could be colored.

In another example, the electro-optic display device of present invention may comprise a first light-transmissive electrode layer, an electro-optic material comprising a plurality of microcells, an optional sealing layer, an optional adhesive layer, and a second light-transmissive electrode layer. The plurality of microcells are separated from each other by transparent partition walls, each microcell of the plurality of microcells having an opening and including electrophoretic medium, the electrophoretic medium comprising charged pigment particles in a non-polar fluid. A watermark that is formed by halftone images from the plurality of microcells, wherein the plurality of microcells comprising more than five types of microcells, each type of microcells having different Fill Factor from all the other types. In this example, the partition walls has the color of the substrate onto which the device is attached. The substrate may be a printed image, making the watermark appearance very complex and potentially enhancing its aesthetic and authenticating value of the device. Furthermore, two or more similar or dissimilar such devices may be stacked onto a substrate, enhancing the complexity and the watermark value even further.

In the case that the electro-optic display device comprises a layer that is colored, the color may have a color selected from the group consisting of white, black, gray, magenta, cyan, yellow, blue, green, red, orange, violet, and combinations thereof. The layer may also have a metallic shade.

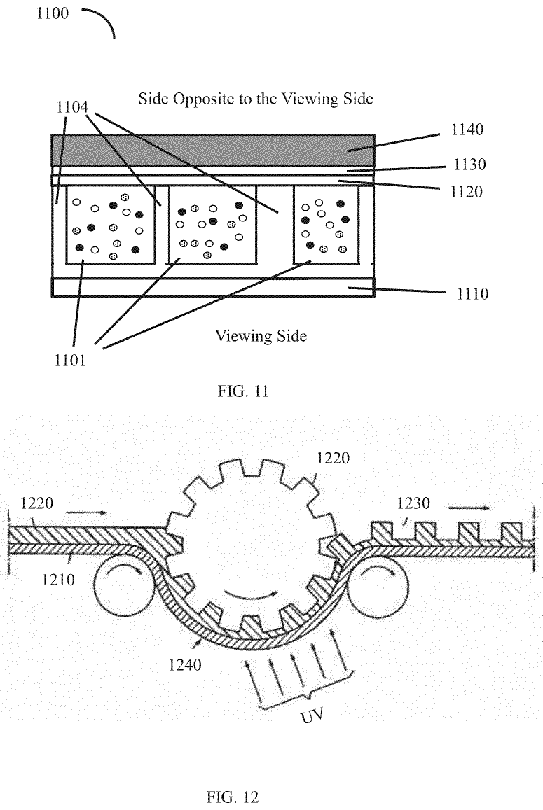

Techniques for constructing microcells. Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic display devices. Microcell arrays suitable for use with the invention can be created with microembossing, as illustrated in FIG. 12. A male mold 1220 may be placed either above the web 1240, as shown in FIG. 12, or below the web 1240 (not shown); however alternative arrangements are possible. See U.S. Pat. No. 7,715,088, which is incorporated herein by reference in its entirety. A conductive substrate may be constructed by forming a conductor film 1210 (first electrode) on polymer substrate that becomes the backing for a device. A composition comprising a thermoplastic, thermoset, or a precursor thereof 1220 is then coated on the conductor film. The thermoplastic or thermoset precursor layer is embossed at a temperature higher than the glass transition temperature of the thermoplastics or thermoset precursor layer by the male mold in the form of a roller, plate or belt.

The thermoplastic or thermoset precursor for the preparation of the microcells may be multifunctional acrylate or methacrylate, vinyl ether, epoxide and oligomers or polymers thereof, and the like. A combination of multifunctional epoxide and multifunctional acrylate is also very useful to achieve desirable physico-mechanical properties. A crosslinkable oligomer imparting flexibility, such as urethane acrylate or polyester acrylate, may be added to improve the flexure resistance of the embossed microcells. The composition may contain polymer, oligomer, monomer and additives or only oligomer, monomer and additives. The glass transition temperatures (or T_{g}) for this class of materials usually range from about −70° C. to about 150° C., preferably from about −20° C. to about 50° C. The microembossing process is typically carried out at a temperature higher than the T_{g}. A heated male mold or a heated housing substrate against which the mold presses may be used to control the microembossing temperature and pressure.

As shown in FIG. 12, the mold is released during or after the precursor layer is hardened to reveal an array of microcells 1230. The hardening of the precursor layer may be accomplished by cooling, solvent evaporation, cross-linking by radiation, heat or moisture. If the curing of the thermoset precursor is accomplished by UV radiation, UV may radiate onto the transparent conductor film from the bottom or the top of the web. Alternatively, UV lamps may be placed inside the mold. In this case, the mold must be transparent to allow the UV light to radiate through the pre-patterned male mold on to the thermoset precursor layer. A male mold may be prepared by any appropriate method, such as a diamond turn process or a photoresist process followed by either etching or electroplating. A master template for the male mold may be manufactured by any appropriate method, such as electroplating. With electroplating, a glass base is sputtered with a thin layer (typically 3000 Å) of a seed metal such as chrome inconel. The mold is then coated with a layer of photoresist and exposed to UV. A mask is placed between the UV and the layer of photoresist. The exposed areas of the photoresist become hardened. The unexposed areas are then removed by washing them with an appropriate solvent. The remaining hardened photoresist is dried and sputtered again with a thin layer of seed metal. The master is then ready for electroforming. A typical material used for electroforming is nickel cobalt. Alternatively, the master can be made of nickel by electroforming or electroless nickel deposition. The floor of the mold is typically between about 50 to 400 microns. The master can also be made using other microengineering techniques including e-beam writing, dry etching, chemical etching, laser writing or laser interference as described in “Replication techniques for micro-optics”, SPIE Proc. Vol. 3099, pp. 76-82 (1997). Alternatively, the mold can be made by photomachining using plastics, ceramics or metals.

Prior to applying a UV curable resin composition, the mold may be treated with a mold release to aid in the demolding process. The UV curable resin may be degassed prior to dispensing and may optionally contain a solvent. The solvent, if present, readily evaporates. The UV curable resin is dispensed by any appropriate means such as, coating, dipping, pouring or the like, over the male mold. The dispenser may be moving or stationary. A conductor film is overlaid the UV curable resin. Pressure may be applied, if necessary, to ensure proper bonding between the resin and the plastic and to control the thickness of the floor of the microcells. The pressure may be applied using a laminating roller, vacuum molding, press device or any other like means. If the male mold is metallic and opaque, the plastic substrate is typically transparent to the actinic radiation used to cure the resin. Conversely, the male mold can be transparent and the plastic substrate can be opaque to the actinic radiation. To obtain good transfer of the molded features onto the transfer sheet, the conductor film needs to have good adhesion to the UV curable resin that should have a good release property against the mold surface.

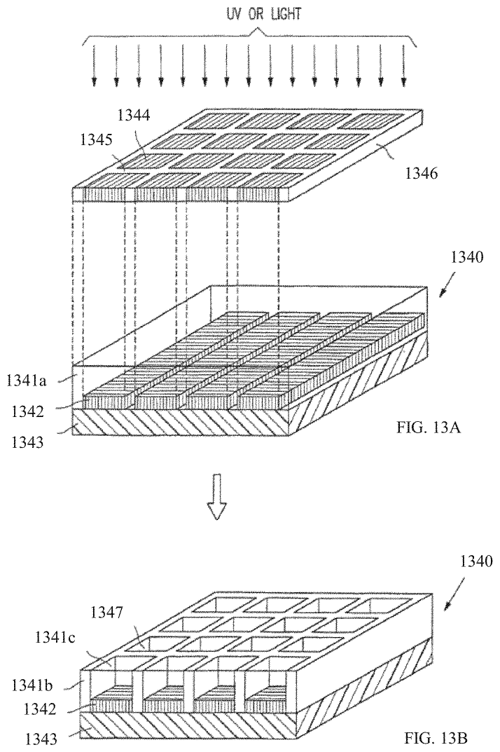

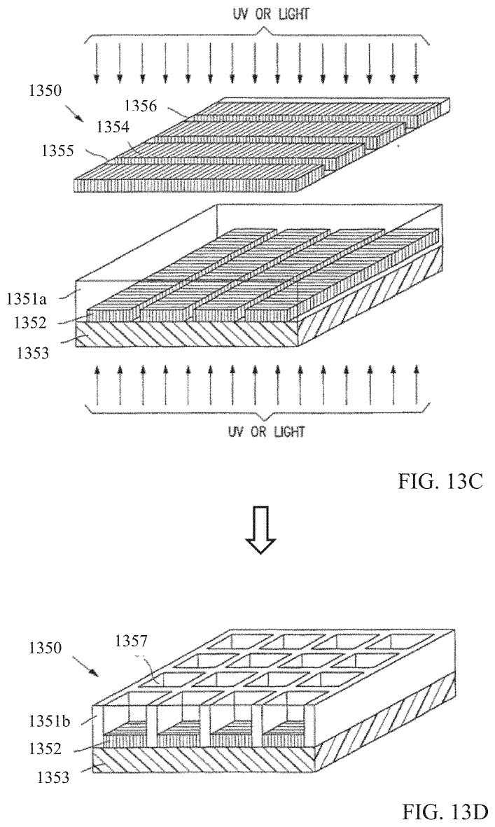

Photolithography. Microcells can also be produced using photolithography. Photolithographic processes for fabricating a microcell array are illustrated in FIGS. 13A and 13B. As shown in FIGS. 13A and 13B, the microcell array 1340 may be prepared by exposure of a radiation curable material 1341a coated by known methods onto a conductor electrode film 1342 to UV light (or alternatively other forms of radiation, electron beams and the like) through a mask 1346 to form partition walls 1341b corresponding to the image projected through the mask 1346. The base conductor film 1342 is preferably mounted on a supportive substrate base web 1343, which may comprise a plastic material.

In the photomask 1346 in FIG. 13A, the dark squares 1344 represent the opaque area and the space between the dark squares represents the transparent area 1345 of the mask 1346. The UV radiates through the transparent area 1345 onto the radiation curable material 1341a. The exposure is preferably performed directly onto the radiation curable material 1341a, i.e., the UV does not pass through the substrate 1343 or base conductor 1342 (top exposure). For this reason, neither the substrate 1343, nor the conductor 1342, needs to be transparent to the UV or other radiation wavelengths employed.

As shown in FIG. 13B, the exposed areas 1341b become hardened and the unexposed areas (protected by the opaque area 1344 of the mask 1346) are then removed by an appropriate solvent or developer to form the microcells 1347. The solvent or developer is selected from those commonly used for dissolving or reducing the viscosity of radiation curable materials such as methylethylketone (MEK), toluene, acetone, isopropanol or the like. The preparation of the microcells may be similarly accomplished by placing a photomask underneath the conductor film/substrate support web and in this case the UV light radiates through the photomask from the bottom and the substrate needs to be transparent to radiation.

Imagewise Exposure. Still another alternative method for the preparation of the microcell array of the invention by imagewise exposure is illustrated in FIGS. 13C and 13D. When opaque conductor lines are used, the conductor lines can be used as the photomask for the exposure from the bottom. Durable microcell partition walls are formed by additional exposure from the top through a second photomask having opaque lines perpendicular to the conductor lines. FIG. 13C illustrates the use of both the top and bottom exposure principles to produce the microcell array 1350 of the invention. The base conductor film 1352 is opaque and line-patterned. The radiation curable material 1351a, which is coated on the base conductor 1352 and substrate 1353, is exposed from the bottom through the conductor line pattern 1352, which serves as the first photomask. A second exposure is performed from the “top” side through the second photomask 1356 having a line pattern perpendicular to the conductor lines 1352. The spaces 1355 between the lines 1354 are substantially transparent to the UV light. In this process, the partition wall material 1351b is cured from the bottom up in one lateral orientation, and cured from the top down in the perpendicular direction, joining to form an integral microcell 1357. As shown in FIG. 13D, the unexposed area is then removed by a solvent or developer as described above to reveal the microcells 1357.

The microcells may be constructed from thermoplastic elastomers, which have good compatibility with the microcells and do not interact with the electrophoretic media. Examples of useful thermoplastic elastomers include ABA, and (AB)n type of di-block, tri-block, and multi-block copolymers wherein A is styrene, α-methylstyrene, ethylene, propylene or norbonene; B is butadiene, isoprene, ethylene, propylene, butylene, dimethylsiloxane or propylene sulfide; and A and B cannot be the same in the formula. The number, n, is ≥1 preferably 1-10. Particularly useful are di-block or tri-block copolymers of styrene or ox-methylstyrene such as SB (poly(styrene-b-butadiene)), SBS (poly(styrene-b-butadiene-b-styrene)), SIS (poly(styrene-b-isoprene-b-styrene)), SEBS (poly(styrene-b-ethylene/butylenes-b-stylene)) poly(styrene-b-dimethylsiloxane-b-styrene), poly((α-methylstyrene-b-isoprene), poly(α-methylstyrene-b-isoprene-b-α-methylstyrene), poly(α-methylstyrene-b-propylene sulfide-b-α-methylstyrene), poly(α-methylstyrene-b-dimethylsiloxane-b-α-methylstyrene). Commercially available styrene block copolymers such as Kraton D and G series (from Kraton Polymer, Houston, Tex.) are particularly useful. Crystalline rubbers such as poly(ethylene-co-propylene-co-5-methylene-2-norbomene) or EPDM (ethylene-propylene-diene terpolymer) rubbers such as Vistalon 6505 (from Exxon Mobil, Houston, Tex.) and their grafted copolymers have also been found very useful.

The thermoplastic elastomers may be dissolved in a solvent or solvent mixture that is immiscible with the display fluid in the microcells and exhibits a specific gravity less than that of the display fluid. Low surface tension solvents are preferred for the overcoating composition because of their better wetting properties over the microcell partition walls and the electrophoretic fluid. Solvents or solvent mixtures having a surface tension lower than 35 dyne/cm are preferred. A surface tension of lower than 30 dyne/cm is more preferred. Suitable solvents include alkanes (preferably C₆₋₁₂ alkanes such as heptane, octane or Isopar solvents from Exxon Chemical Company, nonane, decane and their isomers), cycloalkanes (preferably C₆₋₁₂ cycloalkanes such as cyclohexane and decalin and the like), alkylbezenes (preferably mono- or di-C₁₋₆ alkyl benzenes such as toluene, xylene and the like), alkyl esters (preferably C₂₋₅ alkyl esters such as ethyl acetate, isobutyl acetate and the like) and C₃₋₅ alkyl alcohols (such as isopropanol and the like and their isomers). Mixtures of alkylbenzene and alkane are particularly useful.

In addition to polymer additives, the polymer mixtures may also include wetting agents (surfactants). Wetting agents (such as the FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn.) may also be included in the composition to improve the adhesion of the sealant to the microcells and provide a more flexible coating process. Other ingredients including crosslinking agents (e.g., bisazides such as 4,4′-diazidodiphenylmethane and 2,6-di-(4′-azidobenzal)-4-methylcyclohexanone), vulcanizers (e.g., 2-benzothiazolyl disulfide and tetramethylthiuram disulfide), multifunctional monomers or oligomers (e.g., hexanediol, diacrylates, trimethylolpropane, triacrylate, divinylbenzene, diallylphthalene), thermal initiators (e.g., dilauroryl peroxide, benzoyl peroxide) and photoinitiators (e.g., isopropyl thioxanthene (ITX), Irgacure 651 and Irgacure 369 from Ciba-Geigy) are also highly useful to enhance the physico-mechanical properties of the sealing layer by crosslinking or polymerization reactions during or after the overcoating process.

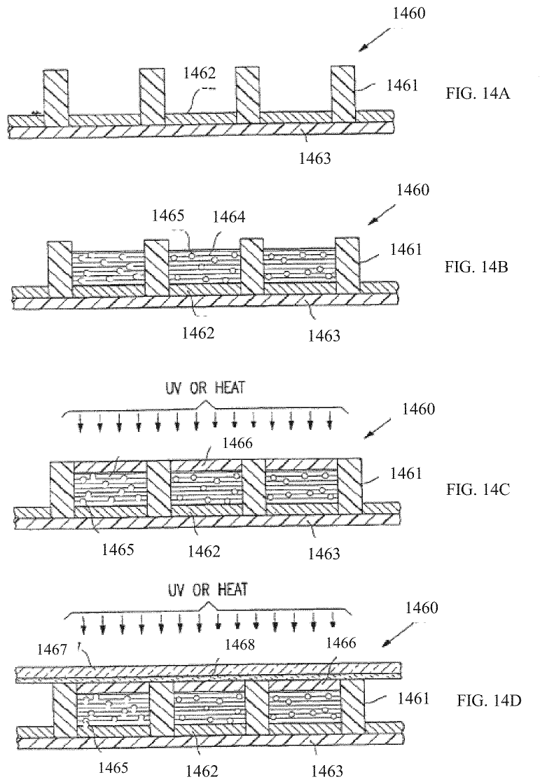

After the microcells are produced, they are filled with appropriate electrophoretic media. The microcell array 1460 may be prepared by any of the methods described above. As shown in cross-section in FIGS. 14A-14D, the microcell partition walls 1461 extend upward from the substrate 1463 to form the open cells. The microcells may include a primer layer 1462 to passivate the mixture and keep the microcell material from interacting with the mixture containing the electrophoretic medium 1465.

The microcells are next filled with an electrophoretic medium 1464 comprising charged pigment particles 1465 in a non-polar fluid. The microcells may be filled using a variety of techniques. In sonic examples, blade coating may be used to fill the microcells to the depth of the microcell partition walls 1461. In other examples, inkjet-type microinjection can be used to fill the microcells. In yet other examples, microneedle arrays may be used to fill an array of microcells.

As shown in FIG. 14C, after filling, the microcells are sealed by applying a polymer 1466 that becomes the sealing layer. In some examples, the sealing process may involve exposure to heat, dry hot air, or UV radiation. Polymer 1466 is compatible with the electrophoretic medium, but not dissolved by the fluid of the electrophoretic medium 1464. Accordingly, the final microcell structure is mostly impervious to leaks and able to withstand flexing without delamination.

A variety of individual microcells may be filled with the desired electrophoretic medium by using iterative photolithography. The process typically includes coating an array of empty microcells with a layer of positively working photoresist, selectively opening a certain number of the microcells by imagewise exposing the positive photoresist, followed by developing the photoresist, filling the opened microcells with the desired mixture, and sealing the filled microcells by a sealing process.

After the microcells 1460 are filled, the sealed array may be laminated with a finishing layer 1468, preferably by pre-coating the finishing layer 1468 with an adhesive layer that may be a pressure sensitive adhesive, a hot melt adhesive, or a heat, moisture, or radiation curable adhesive. The laminate adhesive may be post-cured by radiation such as UV through the top conductor film if the latter is transparent to the radiation.

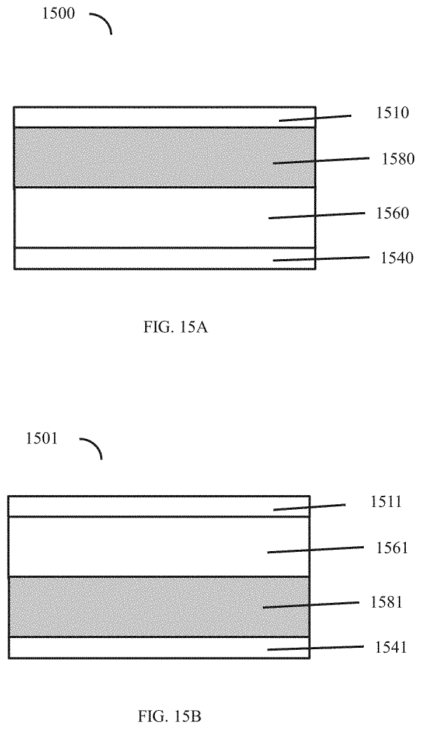

The electro-optic display device of the present device may comprise a piezoelectric layer, enabling the operation of the device with the need of external energy supply. FIG. 15A illustrates an example of such device. The electro-optic display 1500 of FIG. 15 comprises a first electrode 1510, a second electrode 1540, a piezoelectric layer 1580 comprising a piezoelectric material, and an electro-optic material layer 1560 comprising a plurality of microcells. The device may also comprise one or more adhesive layers for bonding together two adjacent layers. The one or more adhesive layers may be transparent. At least one of the electrode layers is light-transmissive. Both electrode layers may be light-transmissive. That is, all the layers of device 1500 may be transparent. If that is true, the display image may be viewed from both sides. Application of mechanical stress on the piezoelectric layer, for example by bending the device, generates voltage potential that can be utilized to cause movement of the color pigments of the electrophoretic material. That is, the optical state of the device may change. This kind of devices that comprise piezoelectric layer can operate without an external voltage source, such as a battery.

Another example of electro-optic display device that comprises a piezoelectric is provided in the electro-optic display 1501 of FIG. 15B. The display device comprises a first electrode 1511, a second electrode 1541, an electro-optic material layer 1561 comprising a plurality of microcells, and a piezoelectric layer comprising a piezoelectric material 1581. The device may also comprise one or more adhesive layers for bonding together two adjacent layers. The one or more adhesive layers may be transparent. At least one of the electrode layers is light-transmissive. Both electrode layers may be light-transmissive. That is, all the layers of device 1501 may be transparent. If that is true, the display image may be viewed from both sides. Application of mechanical stress on the piezoelectric layer, for example by bending the device, generates voltage potential that can be utilized to cause movement of the color pigments of the electrophoretic material. That is, the optical state of the device may change. This kind of devices that comprise piezoelectric layer can operate without an external voltage source, such as a battery.

While the present invention has been described with reference to the specific examples thereof, it should be understood by those skilled in the art that various changes may be made and equivalents may be substituted without departing from the scope of the invention. In addition, many modifications may be made to adapt a particular situation, materials, compositions, processes, process step or steps, to the objective and scope of the present invention. All such modifications are intended to be within the scope of the claims appended hereto.

We claim:

1. An electro-optic display device comprising an electro-optic material layer, the electro-optic material layer comprising a plurality of microcells, the plurality of microcells being separated from each other by partition walls, the partition walls of each microcell having a surface area, each microcell of the plurality of microcells having a microcell opening, the microcell opening having a surface area and a Fill Factor, each microcell of the plurality of microcells including electrophoretic medium, the electrophoretic medium comprising charged pigment particles in a non-polar fluid, the electro-optic display device having a viewing side, a side opposite to the viewing side, and a watermark being formed by halftone images from the plurality of microcells, the plurality of microcells comprising more than five types of microcells, each microcell of a type of microcells having a Fill Factor that is different from the Fill Factors of all microcells of other types of microcells, the Fill Factor of a microcell being determined by Equation 1,
Fill Factor=A₁/ (A₁+A₂) Equation 1,
A₁ being the surface area of the microcell opening, and A₂ being the surface area of the partition walls that surround the microcell.

2. The electro-optic display device of claim 1, wherein the plurality of microcells comprises more than six types of microcells, each microcell of a type of microcells having a Fill Factor that is different from the Fill Factors of all microcells of other types of microcells.

3. The electro-optic display device of claim 1, wherein the electro-optic display device comprises microcells having the same Fill Factor, but different partition wall height.

4. The electro-optic display device of claim 1, wherein the electro-optic display device comprises microcells having the same Fill Factor, but different microcell shape.

5. The electro-optic display device of claim 1, wherein the partition walls are transparent.

6. The electro-optic display device of claim 1, wherein the partition walls are opaque.

7. The electro-optic display device of claim 1, wherein the electro-optic display device comprises at least two types of partition walls, a first type and a second type of partition walls, wherein the first type and the second type of partition walls have different colors.

8. The electro-optic display device of claim 1, further comprising a first light-transmissive electrode layer and a second electrode layer, wherein the electro-optic material layer is disposed between the first light-transmissive electrode layer and the second electrode layer.

9. The electro-optic display device of claim 8, wherein the second electrode layer is light-transmissive.

10. The electro-optic display device of claim 8, wherein the second electrode layer is colored.

11. The electro-optic display device of claim 8, further comprising a sealing layer, the sealing layer spanning the opening of each microcell of the plurality of microcells, the sealing layer being disposed between the electro-optic material layer and the second electrode layer.

12. The electro-optic display device of claim 11, wherein the sealing layer is transparent.

13. The electro-optic display device of claim 11, wherein the sealing layer is colored.

14. The electro-optic display device of claim 11, wherein the electro-optic display device further comprises an adhesive layer disposed between the sealing layer and the second electrode layer.

15. The electro-optic display device of claim 14, wherein the adhesive layer is transparent.

16. The electro-optic display device of claim 14, wherein the adhesive layer is colored.

17. The electro-optic display device of claim 1, further comprising a piezoelectric layer comprising piezoelectric material.

18. The electro-optic display device of claim 17, wherein the piezoelectric layer is located adjacent to the electro-optic material layer.

19. The electro-optic display device of claim 7, further comprising a photovoltaic layer.

20. The electro-optic display device of claim 1, wherein the electro-optic display device is used as part of a product, a document, or a currency bill for anti-counterfeiting purpose.
